(19) United States
(12) Patent Application Publication
(10) Pub. No.: US 2011/0305931 A1
(43) Pub. Date: Dec. 15, 2011

(54) Secondary power source and method for manufacturing the same

(75) Inventors: Hong Seok Min, Yongin (KR); Hak Kwan Kim, Hanam (KR); Hyun Chul Jung, Yongin (KR); Dong Hyeok Choi, Suwon (KR); Bae Kyun Kim, Seongnam (KR)

(73) Assignee: SAMSUNG ELECTRO-MECHANICS CO., LTD., Suwon (KR)

(21) Appl. No.: 12/926,847

(22) Filed: Dec. 13, 2010

(30) Foreign Application Priority Data
Jun. 10, 2010 (KR) 10-2010-0054826
Jul. 30, 2010 (KR) 10-2010-0074147
Jul. 30, 2010 (KR) 10-2010-0074148

(51) Int. Cl. H01G 9/155; H01M 4/13; H01G 9/04

(52) U.S. Cl. 429/94; 29/25.03; 361/502; 429/231.95; 156/64

(57) ABSTRACT

Disclosed is a secondary power source and a manufacturing method thereof. The secondary power source includes a unit cell formed by sequentially laminating a first electrode, a separation film, and a second electrode, wherein the first electrode is formed by forming a first electrode material, into which lithium ions can be irreversibly occluded, on a first conductive sheet, and the first electrode is laminated in the unit cell after lithium ions are occluded into the first electrode material by using a metal that can supply lithium ions.

### CROSS-REFERENCE TO RELATED APPLICATIONS

This application claims the priority of Korean Patent Application Nos. 10-2010-0054826 filed on Jun. 10, 2010, 10-2010-0074148 filed on Jul. 30, 2010 and 10-2010-0074147 filed on Jul. 30, 2010, in the Korean Intellectual Property Office, the disclosures of which are incorporated herein by reference.

### BACKGROUND OF THE INVENTION

1. Field of the Invention

The present invention relates to a secondary power source and method for manufacturing the same and, more particularly, to a secondary power source having high energy density and excellent output characteristics, and a method for manufacturing the same.

2. Description of the Related Art

In various electronic products such as an information communication device, and the like, a stable energy supply is an important factor. In general, such a function is performed by a capacitor. Namely, the capacitor serves to collect electricity in circuits of the information communication device and various electronic products and output it, thus stabilizing the flow of electricity within the circuits. A general capacitor has a very short charging and discharging time and a high output density, but because it has a low energy density, it has limitations in being used as an energy storage device.

Thus, in order to overcome such limitations of a general capacitor, recently, a novel capacitor such as an electrical double layer capacitor (EDLC) has been developed, which has come into prominence as a next-generation energy device along with a rechargeable battery or a secondary battery.

Also, recently, diverse electrochemical elements, whose operating principles are based on similar principles to those of an ELDC, have been developed, and an energy storage device called a hybrid capacitor, formed by combining power storage principles of a lithium ion secondary battery and the ELDC, has come into prominence. As a hybrid capacitor, a lithium ion capacitor, in which a hole is penetratingly formed in a surface of a cathode current collector and a first electrode current collector, a first electrode active material that can be reversibly carried by utilized lithium ions, a lithium metal is disposed to oppose a first electrode or a cathode, and lithium ions are carried to the first electrode according to electrochemical contact between the lithium metal and the first electrode or the cathode, has been proposed.

In the lithium ion capacitor, because the hole is penetratingly installed on the surface of the current collector, lithium ions can be moved without being interrupted with by the electrode current collector, so lithium ions can be electrochemically carried to a plurality of laminated first electrodes even in a power storage device including a large number of laminated cells.

However, the lithium ion capacitor has a problem in that it takes a long time to carry or transport lithium ions by using the lithium metal, and the presence of the lithium metal within the assembled cells increases a dead volume.

### SUMMARY OF THE INVENTION

An aspect of the present invention provides a secondary power source having a high energy density and excellent output characteristics, and a method for manufacturing the same.

According to an aspect of the present invention, there is provided a secondary power source including a unit cell formed by sequentially laminating a first electrode, a separation film, and a second electrode, wherein the first electrode is formed by forming a first electrode material, into which lithium ions can be irreversibly occluded, on a first conductive sheet, and the first electrode is laminated in the unit cell after lithium ions are occluded into the first electrode material by using a metal that can supply lithium ions.

The first conductive sheet may be a metallic foil.

The unit cell may have a form such that the sequentially laminated first electrode, separation film, and second electrode are wound.

The first electrode may be opposed to a metal, which can supply lithium ions, as a counter electrode, and lithium ions are occluded to the first electrode according to a first operation in which charging is performed under a constant current condition of 0.01 mA/cm² to 1 mA/cm² and a second operation in which charging is performed under a constant voltage condition of 0.01 V to 0.1 V.

A plurality of first electrodes and a plurality of metals that can supply lithium ions may be disposed to occlude lithium ions into the first electrodes.

The first electrode and the metal that can supply lithium ions may be electrically short-circuited to occlude lithium ions into the first electrode.

The electrode and the metal that can supply lithium ions, may be brought into contact with each other and heat may be applied to them to occlude lithium ions into the first electrode.

The first electrode and the metal that can supply lithium ions may be brought into contact with each other and electrically short-circuited to occlude lithium ions into the first electrode.

The secondary power source may be formed by laminating a plurality of unit cells.

According to another aspect of the present invention, there is provided a lithium ion capacitor including a unit cell formed by sequentially laminating a first electrode, a separation film, and a second electrode, wherein the first electrode is formed by forming a first electrode material, into which lithium ions can be irreversibly occluded, on a first conductive sheet, and the first electrode is laminated in the unit cell after lithium ions are occluded into the first electrode material by using a metal that can supply lithium ions.

According to another aspect of the present invention, there is provided a method for manufacturing a secondary power source, including: preparing a first electrode by forming a first electrode material, into which lithium ions can be irreversibly occluded, on a first conductive sheet; occluding lithium ions into the first electrode by using the metal that can supply lithium ions; preparing a second electrode by forming a second electrode material on a second conductive sheet; and sequentially laminating the first electrode, a separation film, and the second electrode to form a unit cell.

The method may further include: measuring the amount of lithium ions occluded into the first electrode.

The occluding of lithium ions into the first electrode may be performed with the first electrode and the metal that can supply lithium ions as a counter electrode and may include: a first operation in which charging is performed under a constant current condition of 0.01 mA/cm² to 1 mA/cm² and a second step in which charging is performed under a constant voltage condition of 0.01 V to 0.1 V.

A plurality of first electrodes and a plurality of metals that can supply lithium ions may be disposed to perform occlusion.

The occluding of lithium ions into the first electrode may be performed by electrically short-circuiting the first electrode and the metal that can supply lithium ions.

The occluding of lithium ions into the first electrode may be performed by bringing the first electrode and the metal that can supply lithium ions into contact with each other and applying heat to the first electrode and the metal that can supply lithium ions.

The occluding of lithium ions into the first electrode may be performed by bringing the first electrode and the metal that can supply lithium ions into contact with each other and electrically short-circuiting them.

The method may further include: laminating a plurality of unit cells.

According to another aspect of the present invention, there is provided a method for manufacturing a lithium ion capacitor, including: preparing a first electrode by forming a first electrode material, into which lithium ions can be irreversibly occluded, on a first conductive sheet; occluding lithium ions into the first electrode by using the metal that can supply lithium ions; preparing a second electrode by forming a second electrode material on a second conductive sheet; and sequentially laminating the first electrode, a separation film, and the second electrode to form a unit cell.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view of a first electrode according to an exemplary embodiment of the present invention;

FIGS. 2a to 2d illustrate schematic processes of a method for occluding lithium ions into the first electrode according to an exemplary embodiment of the present invention;

FIG. 3a is a schematic perspective view of a capacitor unit cell according to an exemplary embodiment of the present invention;

FIG. 3b is a schematic perspective view of a capacitor cell formed by stacking a plurality of capacitor unit cells according to an exemplary embodiment of the present invention; and

FIGS. 4 to 8 are graphs showing the characteristics of a lithium ion capacitor according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

A secondary power source according to an exemplary embodiment of the present invention refers to an energy storage device that can be used as a main power source in a circuit of an information communication device and various electronic products or serve as an auxiliary electricity supply. Unlike a primary power source, the secondary power source according to an exemplary embodiment of the present invention can be repeatedly charged or discharged in use.

The secondary power source according to an exemplary embodiment of the present invention may include a unit cell in which a first electrode, a separation film, and a second electrode are sequentially laminated. In this case, after a first electrode material, into which lithium ions can be reversibly occluded, is formed on the first electrode and lithium ions are occluded into the first electrode material by using a metal that can supply lithium ions to the first electrode, the first electrode may be laminated in the unit cell.

A secondary power source according to another exemplary embodiment of the present invention may be formed by laminating a plurality of unit cells, and in this case, a unit cell (C) may be defined as being comprised of a first electrode, a separation film, and a second electrode, as laminated.

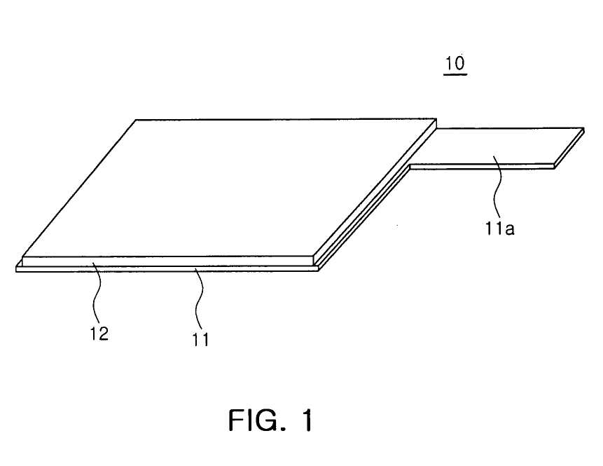

An example of the secondary power source according to an exemplary embodiment of the present invention may be an electrochemical capacitor, and hereinafter, a lithium ion capacitor, as an example of the electrochemical capacitor, will be described with reference to FIGS. 1 to 3.

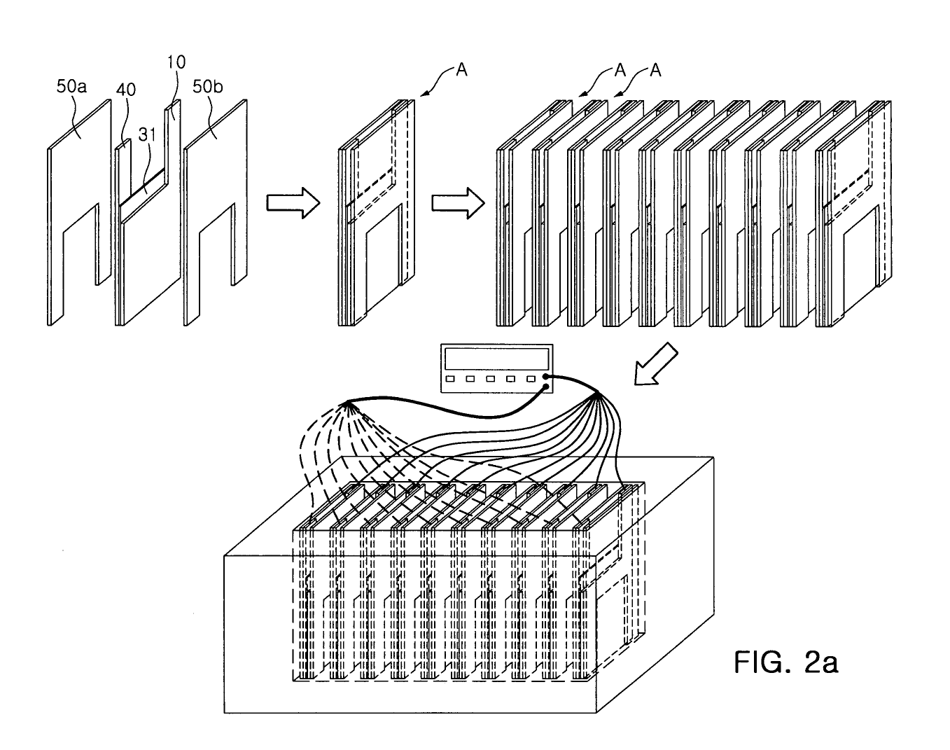

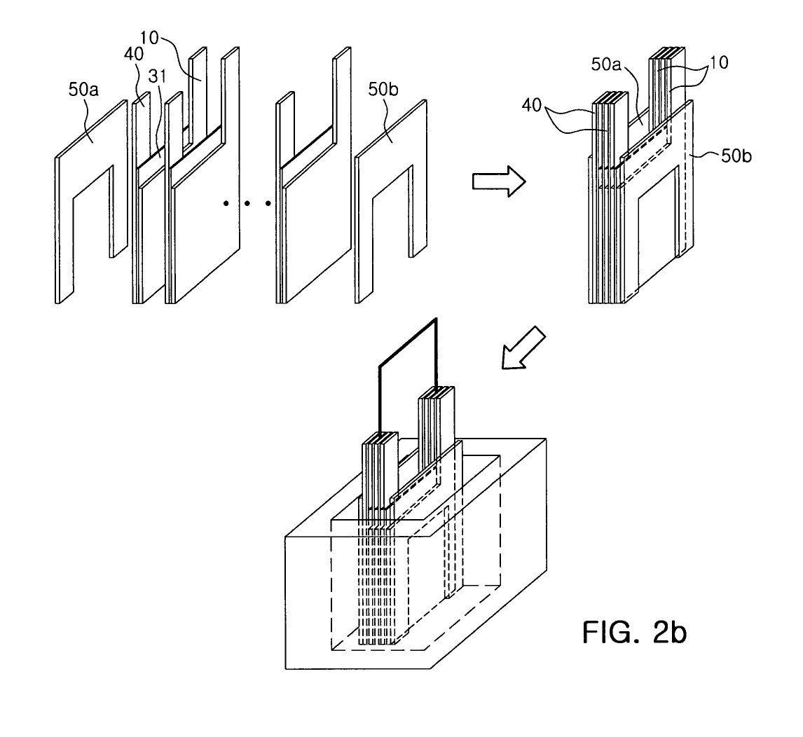

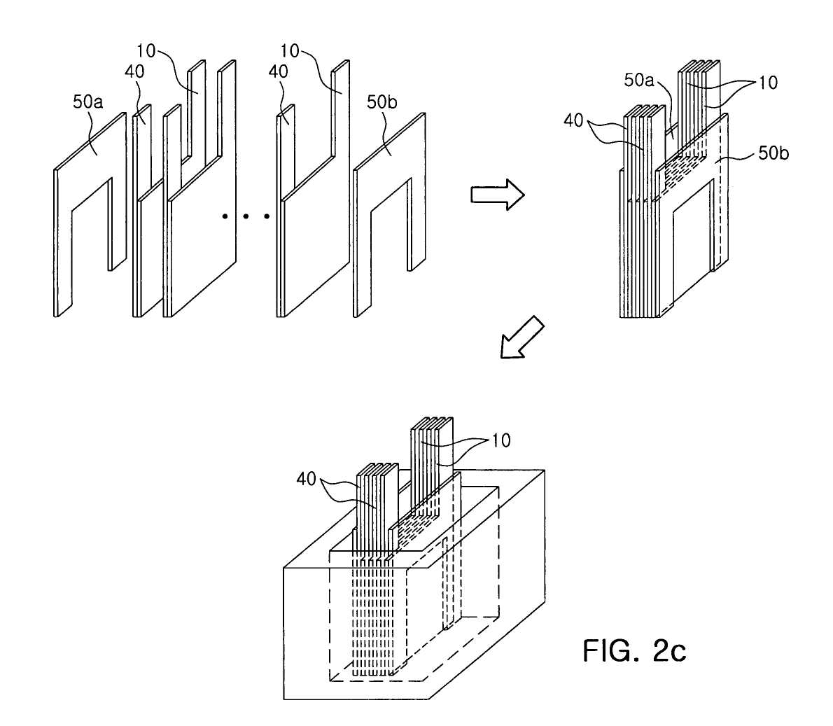

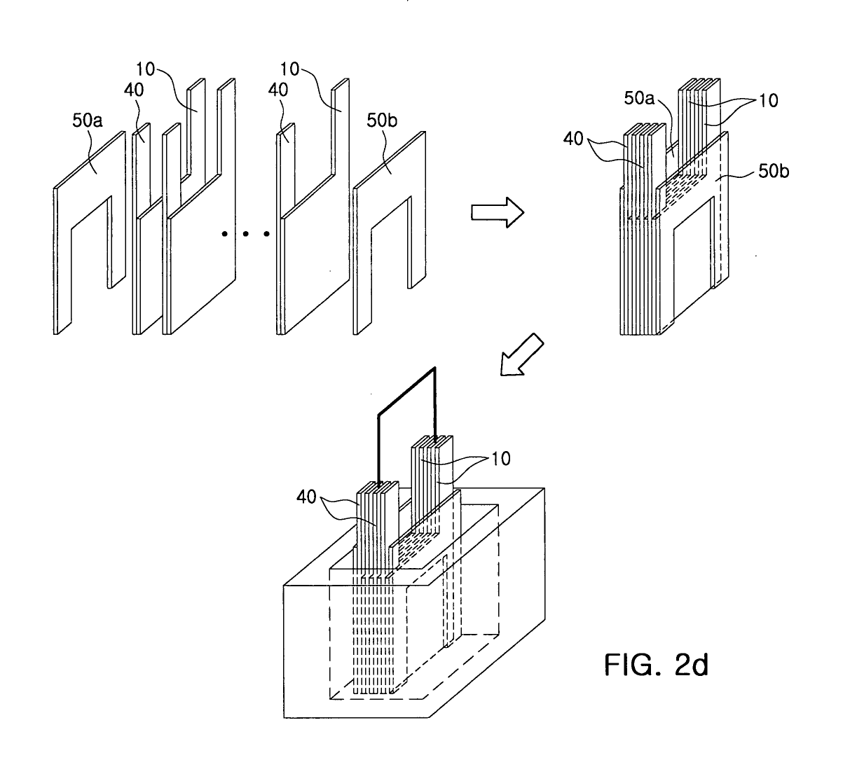

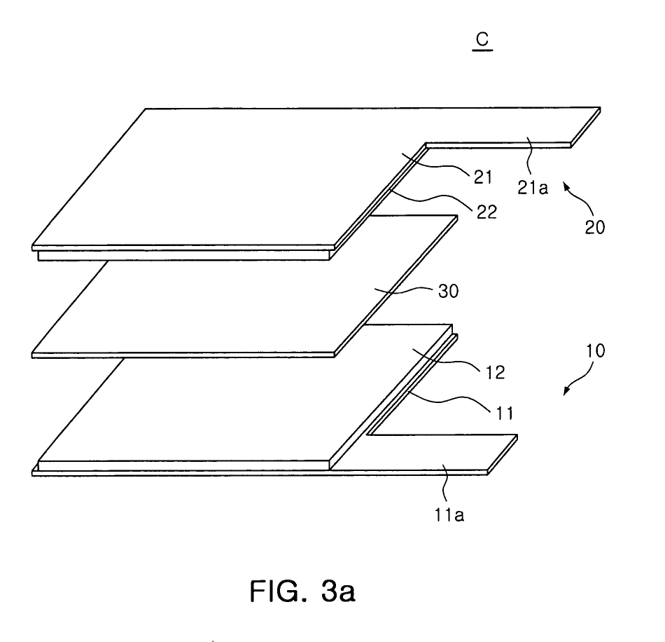

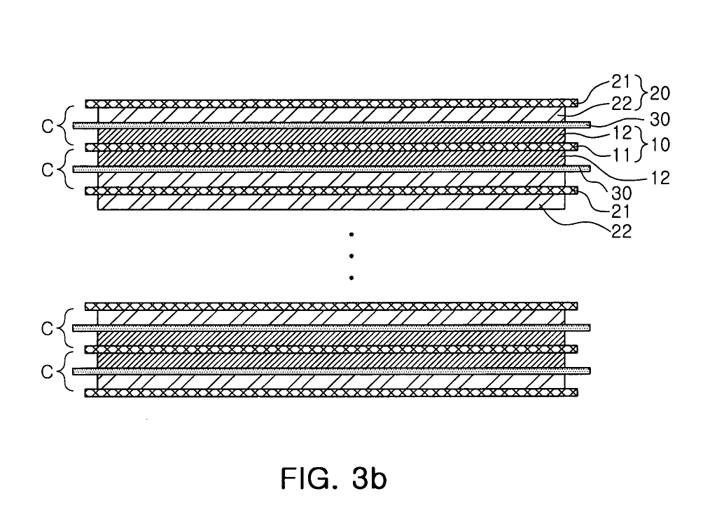

FIG. 1 is a schematic perspective view of a first electrode according to an exemplary embodiment of the present invention. FIGS. 2a to 2d illustrate schematic processes of a method for occluding lithium ions into the first electrode according to an exemplary embodiment of the present invention. FIG. 3a is a schematic perspective view of a capacitor unit cell according to an exemplary embodiment of the present invention. FIG. 3b is a schematic perspective view of a capacitor cell formed by stacking a plurality of capacitor unit cells according to an exemplary embodiment of the present invention.

As shown in FIG. 3a, a lithium ion capacitor according to an exemplary embodiment of the present invention may include a capacitor unit cell (C) comprised of a first electrode 10, a second electrode 20, and a separation film 30 disposed between the first and second electrodes 10 and 20.

Also, a lithium ion capacitor according to another exemplary embodiment of the present invention may be formed by laminating a plurality of capacitor unit cells, and in this case, a capacitor unit cell (C) may be defined as being comprised of a first electrode, a separation film, and a second electrode as laminated.

The lithium ion capacitor according to an exemplary embodiment of the present invention may be manufactured in the following manner, which will now be described in detail as follows.

First, as shown in FIG. 1, a first electrode material 12 is formed on a first conductive sheet 11 to prepare the first electrode 10. In the present exemplary embodiment, the first electrode 10 may be set to be an anode, and the second electrode 20 may be set to be a cathode.

The first electrode material 12 may be made of a material into which lithium ions may be reversibly occluded. For example, the first electrode material 12 may be made of a carbon material such as graphite, hard carbon, or coke, a polyacene-based material, or the like, but the present invention is not limited thereto.

The first electrode 10 may be made of a mixture of the first electrode material 12 and a conductive material. As the conductive material, for example, acetylene black, graphite, metal powder, and the like, may be used but the present invention is not limited thereto.

The thickness of the first electrode material 12 may not be particularly limited but may range from 15 μm to 100 μm.

The first conductive sheet 11 delivers an electrical signal to the first electrode material 12 and serves as a current collector for collecting accumulated electrical charges. The first conductive sheet 11 may be formed as a metallic foil or a conductive polymer.

The metallic foil may be made of stainless steel, copper, nickel, aluminum, or the like.

The first conductive sheet 11 may have a first terminal withdrawal part 11a on which the first electrode material is not formed. The first terminal withdrawal part 11a may be connected to an external terminal of a package for applying electricity to the capacitor cell or may be used in the process of occluding lithium ions into the first electrode later.

In the related art, the first electrode material is formed on a current collector having a through hole in order to occlude lithium ions into the first electrode. In this case, however, movable electrode material slurry may be discharged through the through hole of the current collector, and it may therefore be difficult to adjust the thickness.

However, in the present exemplary embodiment, the first conductive sheet has the form of a metallic foil that allows an electrode material to be easily formed and facilitates an adjustment of the thickness. Also, compared with the current collector having the through hole, the first conductive sheet has excellent tension to allow for a fabrication of a winding type capacitor cell.

Next, lithium ions are occluded into the first electrode 10. The method of occluding lithium ions into the first electrode 10 is not particularly limited, but electroplating, electrical shorting, direct diffusion, or electrical shorting and contact diffusion may be used.

FIG. 2a is a schematic view showing the process of the electroplating according to an exemplary embodiment of the present invention.

As shown in FIG. 2a, the first electrode 10 and a metal 40 that can supply lithium ions are disposed to face each other with a separation film 31 interposed therebetween. The metal 40 that can supply lithium ions is not particularly limited. For example, a metal that contains a lithium element such as a lithium metal or a lithium-aluminum alloy and is able to supply lithium ions can be used.

Pressing plates 50a and 50b are disposed on both surface of the first electrode 10 and the metal 40, that can supply lithium ions, disposed in a facing manner, which are then compressed to fabricate a unit body (A).

In the present exemplary embodiment, a plurality of unit bodies (A) are arranged, upon which electroplating is performed. After the plurality of unit bodies (A) are arranged, they are impregnated with an electrolyte. Thereafter, the metal 40 that can supply lithium ions is defined as a counter electrode, which is charged with constant current and constant voltage in order to occlude lithium ions into the first electrode 10.

In detail, the occluding of lithium ions into the first electrode may include a first step in which charging is performed under a constant current condition of 0.01 mA/cm² to 1 mA/cm² and a second step in which charging is performed under a constant voltage condition of 0.01 V to 0.1 V.

At this time, the amount of occluded lithium ions may be measured to optimize the amount of occluded lithium ions. The amount of occluded lithium ions may be measured and adjusted according to electrochemically set conditions and may be optimized according to the capacity of an electrochemical capacitor fabricated.

The foregoing process of occluding lithium ions may be performed in a dry room in order to preserve the lithium ion-occluded first electrode.

FIG. 2b is a schematic view showing the process of the electrical shorting according to an exemplary embodiment of the present invention.

As shown in FIG. 2b, the first electrode 10 and the metal 40 that can supply lithium ions are disposed to face each other with a separation film 31 interposed therebetween.

As discussed above, the metal 40 that can supply lithium ions is not particularly limited. For example, a metal that contains a lithium element such as a lithium metal or a lithium-aluminum alloy and is able to supply lithium ions can be used.

In the present exemplary embodiment, the plurality of first electrodes 10 and the plurality of metals 40 that can supply lithium ions are disposed to face each other with a plurality of separation films 31 interposed therebetween. And then, pressing plates 50a and 50b are disposed on both surfaces of the first electrode 10 and the metals 40, which can supply lithium ions, disposed in a facing manner, which are then compressed.

Thereafter, the first electrodes 10 and the metals that can supply lithium ions are short-circuited to occlude lithium ions into the first electrodes 10. In this case, the amount of occluded lithium ions may be measured to optimize the occlusion amount of the lithium ions.

FIG. 2c is a schematic view showing the process of the direct diffusion according to an exemplary embodiment of the present invention.

As shown in FIG. 2c, the first electrode 10 and the metal 40 that can supply lithium ions are brought into contact with each other. As discussed above, the metal 40 that can supply lithium ions is not particularly limited. For example, a metal that contains a lithium element such as a lithium metal or a lithium-aluminum alloy and is able to supply lithium ions can be used.

In the present exemplary embodiment, the plurality of first electrodes 10 and the plurality of metals 40 that can supply lithium ions may be brought into contact with each other so as to be used. Thereafter, heat is applied to the first electrodes 10 and the metals 40 that can supply lithium ions, which are in contact with each other, to occlude lithium ions from the metals 40 into the first electrodes 10. In this case, the amount of occluded lithium ions may be measured to optimize the occlusion amount of the lithium ions.

FIG. 2d is a schematic view showing the process of the electrical shorting and direct diffusion according to an exemplary embodiment of the present invention.

As shown in FIG. 2d, the first electrode 10 and the metal 40 that can supply lithium ions are brought into contact with each other. As discussed above, the metal 40 that can supply lithium ions is not particularly limited. For example, a metal that contains a lithium element such as a lithium metal or a lithium-aluminum alloy and is able to supply lithium ions can be used.

And then, the first electrodes 10 and the metals 40 are electrically short-circuited. In the present exemplary embodiment, the first electrodes 10 and the metals 40 are electrically short-circuited to directly diffuse lithium ions to the first electrodes.

As shown in FIG. 3a, a second electrode material 22 is formed on a second conductive sheet to prepare a second electrode 20. The second electrode material 22 may be made of activated carbon but is not limited thereto, and the second electrode may be formed by mixing activated carbon, a conductive material, and a binder.

The thickness of the second electrode material may not be particularly limited, and for example, may range from 15 μm to 100 μm.

The second conductive sheet 21 delivers an electrical signal to the first electrode material 12 and serves as a current collector for collecting accumulated electric charges. The first conductive sheet 11 may be formed as a metallic foil or a conductive polymer. The metallic foil may be made of aluminum, copper, nickel, stainless steel, or the like.

The second conductive sheet 21 may have a second terminal withdrawal part 21a on which the first electrode material is not formed. The second terminal withdrawal part 21a may be connected to an external terminal of a package for applying electricity to the capacitor cell.

Thereafter, the separation film 30 is disposed between the first and second electrodes 10 and 20, which are then laminated to form the capacitor unit cell (C).

The separation film 30 may be made of a porous material allowing ion transmission therethrough. In this case, the porous material may include, for example, polypropylene, polyethylene, glass fiber, and the like.

One first electrode 10, one separation film 30, and one second electrode 20 constitute a unit cell (C) of a capacitor, and higher electricity capacity can be obtained by laminating a plurality of unit cells.

As shown in FIG. 3b, a capacitor cell may be formed by laminating a plurality of unit cells (C) of the capacitor.

Thereafter, the capacitor cell is impregnated with an aprotic organic solvent electrolyte of lithium salt to manufacture an electrochemical capacitor.

In the related art, after a plurality of first and second electrodes are laminated, lithium ions are occluded, so a lithium metal for occluding lithium ions is included in the laminated cell. This results in an increase in the size of the capacitor cell, restricting the manufacturing of a small, compact electrochemical capacitor.

However, in the present exemplary embodiment, because the capacitor cell does not include a lithium metal, a dead volume can be reduced.

In addition, en energy density can be improved by optimizing the amount of lithium ions occluded into the first electrode.

Hereinafter, exemplary embodiments and comparative examples will now be described.

### Embodiment 1 and Comparative Example 1

As an electrode material for forming an anode, a graphite group (KS6, Timcal Ltd.) was used, and Super-P (Timcal Ltd.), CMC, and SBR were mixed and dispersed with water in the ratio of 95:3:1.1:1.5 to produce a slurry. The slurry was coated onto both surfaces of a copper current collector, dried, and pressed to form a sheet having a thickness of 80 μm. The sheet was then cut into electrodes of 3 centimeters wide and 4 centimeters long to manufacture an anode. Lithium ions were occluded into the manufactured anode through electrochemical plating. The anode and a lithium metal were electrochemically connected, and then, the potential of the anode was lowered to 0.01 V under a constant current condition of 0.06 mA/cm² in a first step, and the current condition was then maintained for about two hours at a constant voltage of 0.01 V in a second step. Through this process, the potential of each anode was set to be 0.1V or lower.

Non-porous carbon (GS Caltex Corp.) was used as an electrode material for forming a cathode, and carbon black, CMC, and SBR were mixed and dispersed with water in the ratio of 80:10:5:5 to produce a slurry. The slurry was coated onto both surfaces of an aluminum current collector, dried, and pressed to form a sheet having a thickness of 80 μm. The sheet was then cut into electrodes of 3 centimeters wide and 4 centimeters long to manufacture a cathode.

A lithium ion-occluded anode and a lithium ion-occluded cathode were opposed by using a polyethylene-based separation film having a thickness of 25 μm, and eleven pairs of anodes and cathodes were laminated such that they were in contact with each other with the separation film interposed therebetween. An aluminum lead tab was welded to the cathode and a nickel lead tab was welded to the anode to manufacture a capacitor cell.

The manufactured capacitor cell was put into an electrolyte obtained by dissolving LiPF6 with the concentration weight of 1 mol in a mixture solvent (1:1 in volumetric ratio) of ethylene carbonate and dimethyl carbonate, and then, charging and discharging cycles by an initial voltage and current were repeated five times.

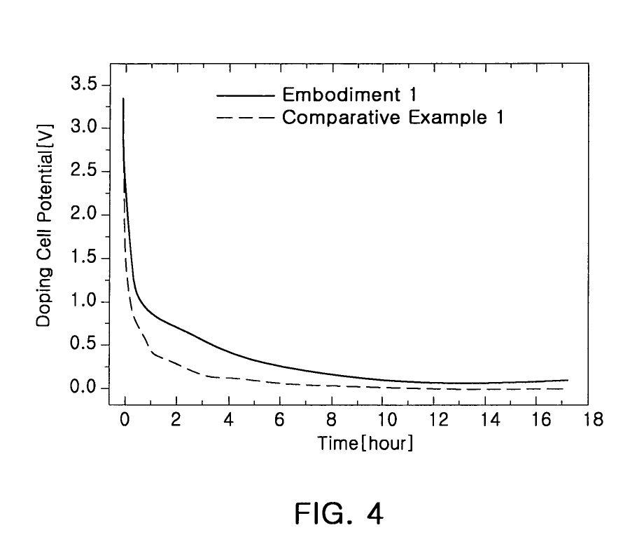

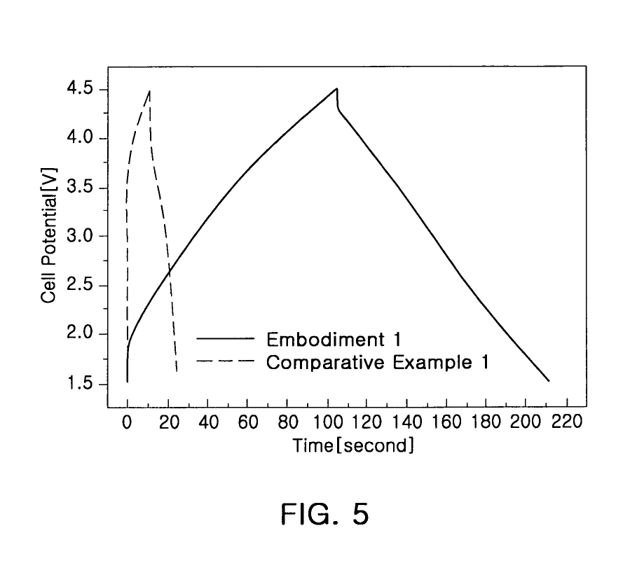

FIGS. 4 and 5 show the capacitor potential and cell performance according to Embodiment 1. In Comparative Example 1, only the first step was performed on the anode in the electrochemical plating. With reference to FIGS. 4 and 5, it is noted that the performance of the capacitor cell is degraded as compared with that of Embodiment 1.

### Embodiments 2 and 3 and Comparative Examples 3 and 4

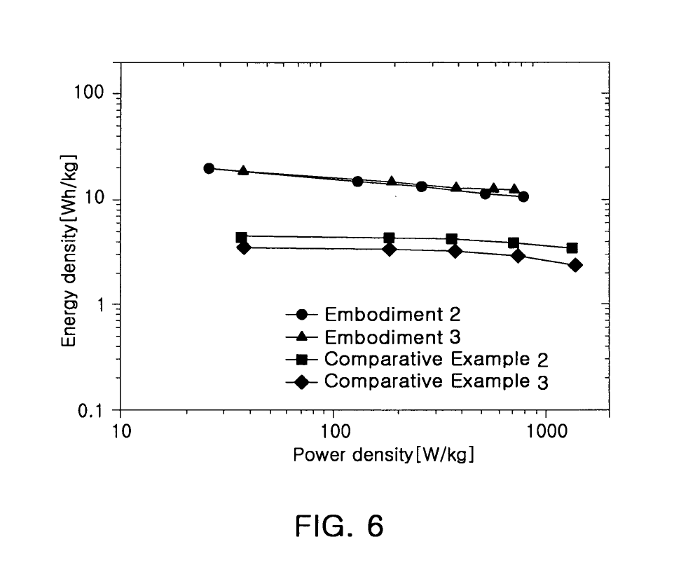

Lithium ions were occluded into the anode manufacture in Embodiment 1 through direct diffusion. The anode with lithium ions occluded thereinto through the direct diffusion was used, and a capacitor cell was manufactured in the same manner as that of Embodiment 1 (Embodiments 2 and 3). FIG. 6 shows the results obtained by comparing the capacity and output as performance of the capacitors according to Embodiments 2 and 3 and the EDLCs (Comparative Examples 2 and 3). The EDLCs, which were cells whose anodes and cathodes were manufactured with non-porous carbon (GS Caltex, Co.) as an electrode material, were evaluated by using commercialized EDLC electrolyte.

With reference to FIG. 6, it is noted that the lithium ion capacitors according to Embodiments 2 and 3 exhibit superior capacity and similar output characteristics compared with the EDLCs according to Comparative Examples 2 and 3.

### Embodiment 4

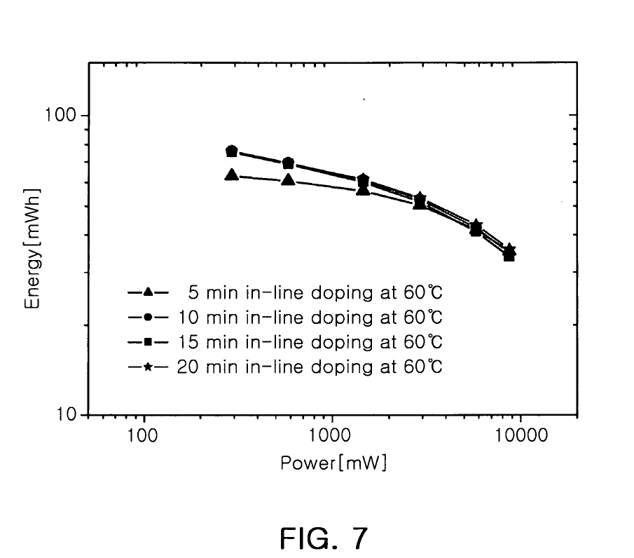

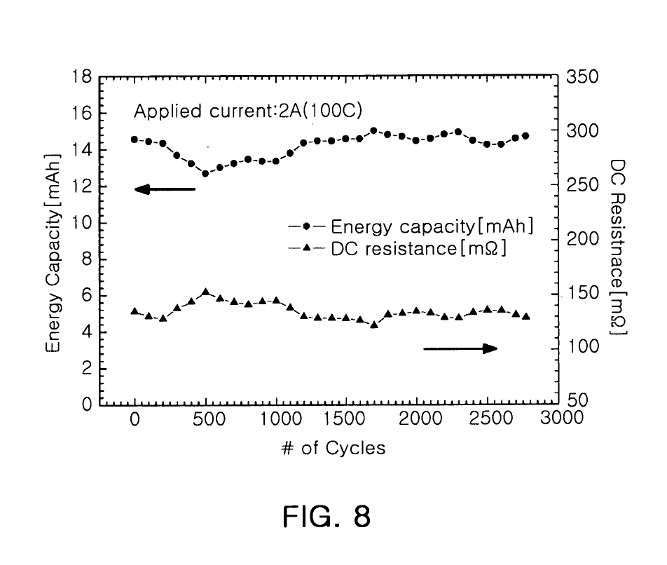

Lithium ions were occluded into the anode manufactured according to Embodiment 1 through electrical shorting. The anode with lithium ions occluded thereinto through the electrical shorting was used, and a capacitor cell was manufactured in the same manner as that of Embodiment 1 (Embodiment 4). FIG. 7 is a graph showing the results of the occlusion of lithium ions into the anode through the electrical short, and FIG. 8 is a graph showing the charging and discharging cycle characteristics of the lithium ion capacitor including the anode manufactured by the electrical shorting and ESR change. With reference to FIG. 8, it is noted that the lithium ion capacitor according to Embodiment 4 exhibits excellent performance such as good charging and discharging cycles, a low ESR, and the like.

As set forth above, according to exemplary embodiments of the invention, a conductive sheet constituting an electrode may be a metallic foil, and thus, an electrode material can be easily formed and its thickness can be easily adjusted. The conductive sheet in the form of a metallic foil has excellent tension, compared with a conductive sheet having a through hole, so it can be fabricated as a winding type secondary power source.

Also, because the secondary power source does not include a lithium metal, the dead volume thereof can be reduced.

In addition, because the amount of lithium ions occluded into the first electrode can be optimized, the energy density thereof can be improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A secondary power source comprising a unit cell formed by sequentially laminating a first electrode, a separation film, and a second electrode,
wherein the first electrode is formed by forming a first electrode material, into which lithium ions can be irreversibly occluded, on a first conductive sheet, and the first electrode is laminated in the unit cell after lithium ions are occluded into the first electrode material by using a metal that can supply lithium ions.

2. The secondary power source of claim 1, wherein the first conductive sheet has a form of a metallic foil.

3. The secondary power source of claim 1, wherein the unit cell has such a form that the sequentially laminated first electrode, separation film, and second electrode are wound.

4. The secondary power source of claim 1, wherein the first electrode is opposed to a metal, which can supply lithium ions, as a counter electrode, and lithium ions are occluded to the first electrode according to a first operation in which charging is performed under a constant current condition of 0.01 mA/cm² to 1 mA/cm² and a second operation in which charging is performed under a constant voltage condition of 0.01 V to 0.1 V.

5. The secondary power source of claim 4, wherein a plurality of first electrodes and a plurality of metals that can supply lithium ions are disposed to occlude lithium ions into the first electrodes.

6. The secondary power source of claim 1, wherein the first electrode and the metal that can supply lithium ions are electrically short-circuited to occlude lithium ions into the first electrode.

7. The secondary power source of claim 1, wherein the first electrode and the metal that can supply lithium ions may be brought into contact with each other and heat is applied to them to occlude lithium ions into the first electrode.

8. The secondary power source of claim 1, wherein the first electrode and the metal that can supply lithium ions may be brought into contact with each other and electrically short-circuited to occlude lithium ions into the first electrode.

9. The secondary power source of claim 1, wherein the secondary power source is formed by laminating a plurality of unit cells.

10. A lithium ion capacitor comprising a unit cell formed by sequentially laminating a first electrode, a separation film, and a second electrode,
wherein the first electrode is formed by forming a first electrode material, into which lithium ions can be irreversibly occluded, on a first conductive sheet, and the first electrode is laminated in the unit cell after lithium ions are occluded into the first electrode material by using a metal that can supply lithium ions.

11. A method for manufacturing a secondary power source, the method comprising:
preparing a first electrode by forming a first electrode material, into which lithium ions can be irreversibly occluded, on a first conductive sheet;
occluding lithium ions into the first electrode by using the metal that can supply lithium ions;
preparing a second electrode by forming a second electrode material on a second conductive sheet; and
sequentially laminating the first electrode, a separation film, and the second electrode to form a unit cell.

12. The method of claim 11, further comprising:
measuring the amount of lithium ions occluded into the first electrode.

13. The method of claim 11, wherein the occluding of lithium ions into the first electrode is performed with the first electrode and the metal that can supply lithium ions as a counter electrode and comprises: a first operation in which charging is performed under a constant current condition of 0.01 mA/cm² to 1 mA/cm² and a second step in which charging is performed under a constant voltage condition of 0.01 V to 0.1 V.

14. The method of claim 13, wherein a plurality of first electrodes and a plurality of metals that can supply lithium ions are disposed to perform occlusion.

15. The method of claim 11, wherein the occluding of lithium ions into the first electrode is performed by electrically short-circuiting the first electrode and the metal that can supply lithium ions.

16. The method of claim 11, wherein the occluding of lithium ions into the first electrode may be performed by bringing the first electrode and the metal that can supply lithium ions into contact with each other and applying heat to the first electrode and the metal that can supply lithium ions.

17. The method of claim 11, wherein the occluding of lithium ions into the first electrode may be performed by bringing the first electrode and the metal that can supply lithium ions into contact with each other and electrically short-circuiting them.

18. The method of claim 11, further comprising:
laminating a plurality of unit cells.

19. A method for manufacturing a lithium ion capacitor, the method comprising:
preparing a first electrode by forming a first electrode material, into which lithium ions can be irreversibly occluded, on a first conductive sheet;
occluding lithium ions into the first electrode by using the metal that can supply lithium ions;
preparing a second electrode by forming a second electrode material on a second conductive sheet; and
sequentially laminating the first electrode, a separation film, and the second electrode to form a unit cell.
